(19) United States
(12) Patent Application Publication
(10) Pub. No.: US 2022/0185335 A1
(43) Pub. Date: Jun. 16, 2022

(54) AUTONOMOUS DRIVING SYSTEM AND CONTROL METHOD OF AUTONOMOUSLY DRIVEN VEHICLE

(71) Applicant: TOYOTA JIDOSHA KABUSHIKI KAISHA, Toyota-shi Aichi-ken (JP)

(72) Inventors: Kazuki Nemoto, Susono-shi Shizuoka-ken (JP); Shin Tanaka, Numazu-shi Shizuoka-ken (JP); Satoshi Nakamura, Susono-shi Shizuoka-ken (JP)

(73) Assignee: TOYOTA JIDOSHA KABUSHIKI KAISHA, Toyota-shi Aichi-ken (JP)

(21) Appl. No.: 17/518,102

(22) Filed: Nov. 3, 2021

(30) Foreign Application Priority Data
Dec. 16, 2020 (JP) 2020-208612

(51) Int. Cl. B60W 60/00; B60W 50/12

(52) U.S. Cl. CPC B60W 60/0053; B60W 50/12

(57) ABSTRACT

An autonomous driving system includes a control device and a request input device. The control device executes one or more controls of a vehicle including an autonomous traveling control. The request input device sends various requests to the control device by a human operation. The control device executes, during execution of the autonomous traveling control, a process for determining whether an operator who operates the request input device is a qualified person. Then, the control device approves the request when the operator is a qualified person, and disapproves the request when the operator is not a qualified person.

### CROSS-REFERENCE TO RELATED APPLICATION

This application claims priority to Japanese Patent Application No. 2020-208612 filed on Dec. 16, 2020, incorporated herein by reference in its entirety.

### BACKGROUND

### 1. Technical Field

The present disclosure relates to safety technology of an autonomous driving system.

### 2. Description of Related Art

Japanese Unexamined Patent Application Publication No. 2019-155956 proposes a vehicle control device that prevents, according to a level of autonomous driving, autonomous driving from being ended by an erroneous operation. The vehicle control device is set such that a driver's operation for ending the autonomous driving or a determination for the operation differs depending on the level of the autonomous driving.

### SUMMARY

A setting change of a vehicle control (including a vehicle safety control or a vehicle stability control in addition to an autonomous traveling control) influences the safety of a vehicle. For this reason, an operation of the setting change may be executed by a qualified person, such as an operator of an autonomously driven vehicle. Further, an operation of manual driving by operating a driving operation system (such as a steering wheel, an accelerator pedal, and a brake pedal) provided in the autonomously driven vehicle may be executed by a qualified person, such as an operator.

However, as a level of the autonomous driving is increased (for example, autonomous driving of level 4 or higher), during execution of the autonomous traveling control, it is conceivable that the operator may not monitor a device used for the setting change or the driving operation system. For this reason, there is a great concern that a third party who is not a qualified person, such as an operator, may operate the setting change or the driving operation system deliberately or by a mistake. This is because, depending on a situation of the operator who is executing the autonomous traveling control, the operator's recognition of such an operation may be delayed or he/she may fail to recognize the operation, such that there is a concern that the safety of the vehicle may not be maintained.

On the other hand, even during the execution of the autonomous traveling control, it is assumed that a qualified person, such as an operator, desires to change the setting of a control or execute the manual driving. Further, a qualified person, such as an operator, may desire to be able to operate the setting change or the driving operation system more easily. For this reason, during the execution of the autonomous traveling control, it may not be desirable to reject any operation or to complicate procedures or a device used for executing the operation.

The present disclosure provides a system and a method used for autonomous traveling that prevents an operation, such as a setting change of a control or an operation of a driving operation system that requires attention, from being executed deliberately or by a mistake by a non-qualified person, such as an operator of an autonomously driven vehicle.

A first aspect of the present disclosure is an autonomous driving system that executes an autonomous traveling control for automatically controlling a traveling of a vehicle. The autonomous driving system includes a control device and a request input device. The control device executes one or more controls of the vehicle including the autonomous traveling control. The request input device sends various requests to the control device by a human operation.

The control device executes, during execution of the autonomous traveling control, an operator determination process for determining whether an operator who operates the request input device is a qualified person. Then, the control device approves the request when the operator is a qualified person, and disapproves the request when the operator is not a qualified person.

The autonomous driving system may further include an operator recognition device that recognizes the operator and outputs operator information on the operator. Then, in the operator determination process, the control device may determine whether the operator is a qualified person based on the operator information.

The control device of the autonomous driving system may execute, based on driving environment information acquired from a sensor provided in the vehicle, a process for calculating a safety risk indicating a risk in terms of safety of the vehicle and a process for calculating a system confidence level indicating reliability of the control executed by the control device. Then, when the safety risk is equal to or higher than a predetermined risk threshold value and the system confidence level is equal to or higher than a predetermined first threshold value, the control device may disapprove the request regardless of whether the operator is a qualified person. Further, when the safety risk is equal to or higher than the predetermined risk threshold value and the system confidence level is lower than a predetermined second threshold value, the control device may approve the request regardless of whether the operator is a qualified person.

A second aspect of the present disclosure is a control method of an autonomously driven vehicle. The control method of the autonomously driven vehicle includes a step of determining, when a request for a control of the autonomously driven vehicle is sent to the control device at a time of execution of an autonomous traveling control by a control device, whether an operator who sends the request is a qualified person, a step of approving the request when the operator is a qualified person, and a step of disapproving the request when the operator is not a qualified person.

The control method may include a step of calculating a safety risk indicating a risk in terms of safety of the autonomously driven vehicle and a system confidence level indicating reliability of the control executed by the control device based on driving environment information indicating a driving environment of the autonomously driven vehicle, and a step of disapproving, when the safety risk is equal to or higher than the predetermined risk threshold value and the system confidence level is equal to or higher than the predetermined first threshold value, the request regardless of whether the operator is a qualified person. Further, the control method may include a step of approving, when the safety risk is equal to or higher than the predetermined risk threshold value and the system confidence level is lower than a predetermined second threshold value, which is lower than the first threshold value, the request regardless of whether the operator is a qualified person.

According to the present disclosure, the request to the control device is approved only when the autonomous traveling control is not being executed, or when the operator is a qualified person even during the execution of the autonomous traveling control. As such, during the execution of the autonomous traveling control, it is possible to prevent the operation that requires attention, such as a control setting change or an operation of the driving operation system, from being executed deliberately or by a mistake by a person other than a qualified person such as an operator of the autonomously driven vehicle.

Further, when the safety risk and the system confidence level are calculated, and the safety risk is equal to or higher than the predetermined risk threshold value and the system confidence level is equal to or higher than the predetermined first threshold value, the request may be disapproved regardless of whether the operator is a qualified person. As such, when the risk of the safety is high to a certain extent, it is possible to entrust the driving of the vehicle to the control of the highly reliable autonomous driving system without being influenced by the setting change and the like. Accordingly, it is possible to enhance the safety of the vehicle.

Further, when the safety risk is equal to or higher than the predetermined risk threshold value and the system confidence level is lower than the predetermined second threshold value, the request may be approved regardless of whether the operator is a qualified person. As such, when reliability of the control of the autonomous driving system is low even when the risk of the safety is high to a certain extent, it is possible to approve even a person other than a qualified person to operate the request input device and entrust a person to make a determination on, for example, the driving of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram illustrating an example of the surroundings of a driver's seat when a vehicle is provided with an HMI device and a driving device;

FIG. 2 is a block diagram illustrating a configuration example of an operation system according to a first embodiment;

FIG. 3 is a flowchart illustrating a process of a request approval determination unit according to the first embodiment;

FIG. 4 is a block diagram illustrating a configuration example of an operation system according to a modified example of the first embodiment;

FIG. 5 is a block diagram illustrating a configuration example of an operation system according to a second embodiment;

FIG. 6 is a flowchart illustrating a process of a request approval determination unit according to the second embodiment;

FIG. 7 is another flowchart illustrating the process of the request approval determination unit according to the second embodiment; and

FIG. 8 is a conceptual diagram illustrating whether a request according to the safety risk and system confidence level implemented by processes illustrated in FIGS. 6 and 7 can be approved.

### DETAILED DESCRIPTION OF EMBODIMENTS

Hereinafter, embodiments of the present disclosure will be described with reference to the drawings. However, when the number, quantity, amount, range, and the like of each element are referred to in the embodiments described below, the applicable embodiment is not limited to the number of the above unless the number is explicitly stated or clearly specified in principle. Further, structures and the like described in the embodiments below are not necessary to the present disclosure unless they are explicitly stated or clearly specified in principle. In each drawing, the same or corresponding parts are denoted by the same reference signs, and the duplicated description thereof will be appropriately simplified or omitted.

Overview

An autonomously driven vehicle capable of autonomous driving is usually provided with a plurality of sensors that detect information on a vehicle state (for example, vehicle speed, acceleration, yaw rate, and the like) or driving environment information such as the information on the surrounding environment (for example, a preceding vehicle, a surrounding target, a vehicle lane, and the like), and a control device that executes autonomous traveling control. The control device is typically an electronic control unit (ECU). The ECU executes processing according to the autonomous traveling control based on the driving environment information. Then, the ECU outputs, to an actuator of the vehicle, a control signal for traveling along a traveling route.

There is a case where the ECU provided in the autonomously driven vehicle executes not only the autonomous traveling control, but also a vehicle safety control (a collision damage mitigation brake, a lane deviation prevention support control, a misstep prevention control, a blind spot monitor, other preventive safety control, and the like), or a vehicle stability control (a side slip prevention control, a traction control, and the like). However, this case also includes a case where each control is executed by several separate ECUs.

These controls including the autonomous traveling control usually have items in which a setting change is possible. Examples of the setting change include operating sensitivity of each control, turning on/off of each control function, or the like. Such a setting change can be typically executed by a person operating a human machine interface (HMI) device provided in the vehicle. Since the setting change of the control influences the safety of the vehicle, the setting change may be recognized by a qualified person, such as an operator of the autonomously driven vehicle.

Further, there is a case where the autonomous driving vehicle is provided with a driving operation system capable of executing manual driving by a human operation (such as a steering wheel, an accelerator pedal, and a brake pedal). The driving operation system is provided in, for example, the surroundings of the driver's seat.

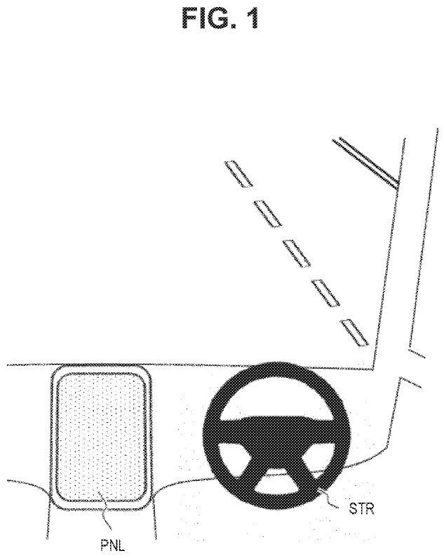

FIG. 1 is a schematic diagram illustrating an example of the surroundings of the driver's seat of a vehicle when the vehicle, which is an autonomously driven vehicle, is provided with a touch panel PNL as an HMI device and a steering wheel STR as a driving operation system. In the example illustrated in FIG. 1, the setting change of the control can be executed by an operation of the touch panel PNL. Further, it is possible to execute a driving operation of steering of the vehicle by an operation of the steering wheel STR.

It is conceivable that such a driver's seat may be applied to autonomously driven vehicles having various forms and purposes, such as a private car or a public bus. On the other hand, as a level of the autonomous driving is increased, it is conceivable that the operator of the autonomously driven vehicle may not monitor the HMI device and the driving operation system. Further, it is conceivable that the operator is away from the driver's seat when, for example, the operator reads a book in a private car during the execution of the autonomous traveling control, or when the operator leaves the driver's seat due to performing an in vehicle task on a public bus during the execution of the autonomous traveling control.

For this reason, there is a great concern that a third party who is not a qualified person, such as an operator, may operate the HMI device or the driving operation system deliberately or by a mistake when, for example, a person sitting in the passenger seat unexpectedly operates the HMI device or the driving operation system in a private car, or when a passenger deliberately operates the HMI device or the driving operation system in a public bus. In this case, depending on the situation of the operator, the operator's recognition of such an operation may be delayed or not recognized, such that there is a concern that the safety of the vehicle may not be maintained.

On the other hand, even during the execution of the autonomous traveling control, it is assumed that an operator desires to execute the setting change of a control or the manual driving. For example, there is a case where the collision damage mitigation brake is unnecessarily activated due to the surrounding environment on a traveling route, or when a driver desires to enjoy driving by himself/herself.

Therefore, during the execution of the autonomous traveling control, the autonomous driving system according to the present embodiment determines whether an operator who operates the HMI device or the driving operation system is a qualified person, such as an operator. Then, during the execution of the autonomous traveling control, the request to the control device by an operation is approved only when the operator is a qualified person. As such, during the execution of the autonomous traveling control, the operation that requires attention, such as a control setting change or an operation of the driving operation system, is prevented from being executed deliberately or by a mistake by a person other than a qualified person, such as an operator of the autonomously driven vehicle.

### First Embodiment

Configuration

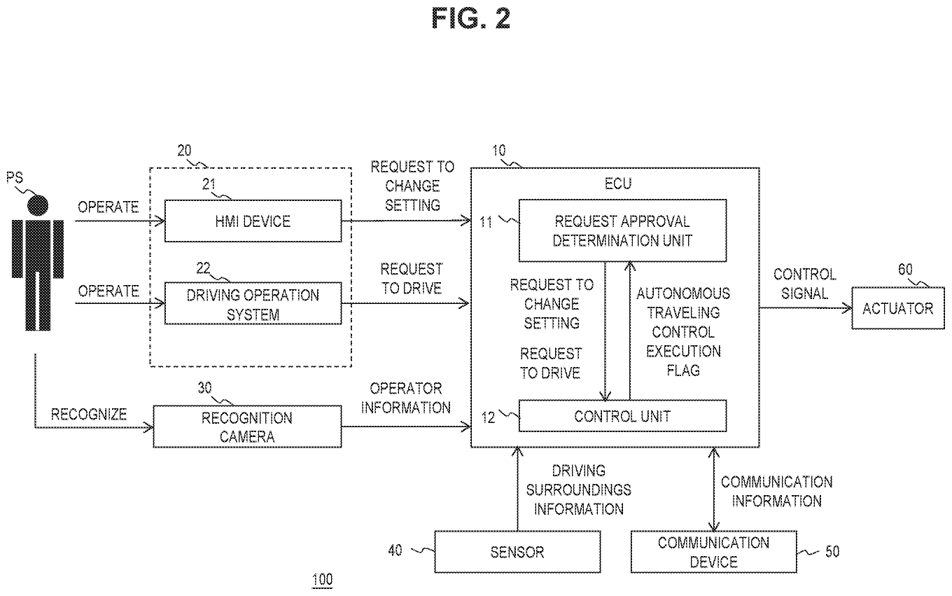

FIG. 2 is a block diagram illustrating a configuration example of an autonomous driving system 100 according to a first embodiment. The autonomous driving system 100 includes an ECU 10, a request input device 20, a recognition camera 30, a sensor 40, a communication device 50, and an actuator 60. The ECU 10 is electrically or wirelessly connected to the request input device 20, the recognition camera 30, the sensor 40, the communication device 50, and the actuator 60, and is configured to be capable of transmitting information.

The request input device 20 sends various requests to the ECU 10 by a human operation (an operator PS). In a configuration example illustrated in FIG. 1, the HMI device 21 and the driving operation system 22 are illustrated as the request input device 20. However, only one of them may be used as the request input device 20, or the other device that sends a request to the ECU 10 may be used as the request input device 20.

Examples of the HMI device 21 include a switch, a touch panel, or a car navigation system provided in the vehicle. The operator PS can execute the setting change of the control executed by the ECU 10 by an operation of the HMI device 21. At this time, the HMI device 21 sends a setting change request to the ECU 10. The setting change request includes a setting change value indicating a change value requested for an item which is a target for the setting change.

Examples of the driving operation system 22 include a steering wheel, an accelerator pedal, a brake pedal, and the like, provided in the vehicle. The operator PS can operate the vehicle by operating the driving operation system 22. In other words, the operator PS can operate the driving operation system 22 and executes the manual driving. At this time, the driving operation system 22 sends a driving request to the ECU 10. The driving request includes an operation amount of the driving operation system 22 (a steering angle of the steering wheel, a depression amount of the accelerator pedal, and the like).

The recognition camera 30 (an operator recognition device) captures an image of the operator PS, and outputs information on the face or clothes of the operator PS as operator information by image recognition processing. Alternatively, a process for determining whether the operator PS is a qualified person may be executed based on the information on the face or clothes of the operator PS, and the information on whether the operator PS is a qualified person may be output as the operator information. In this case, the recognition camera 30 is provided in advance with criteria (data on the face or clothes of the qualified person, and the like) for determining whether the person is a qualified person.

The recognition camera 30 is arranged at a position at which the image of the operator PS can be captured to such an extent that the operator information on the operator PS can be acquired. For example, it may be arranged near the request input device 20 so as to face the operator PS. Alternatively, it may be arranged on the ceiling of the vehicle so as to capture an image of the entire inside of the vehicle. A plurality of recognition cameras 30 may be provided in the vehicle and each may be configured to output different pieces of operator information.

The sensor 40 detects and outputs the driving environment information. Examples of the sensor 40 include a wheel speed sensor, a G sensor, a yaw rate sensor, and the like, that detect information on the vehicle state. A camera, a radar, light detection and ranging (LIDAR), and the like are used to detect information on the surrounding environment of the vehicle.

The communication device 50 acquires and outputs information (communication information) by communicating with the vehicle and the outside of the vehicle. The communication device 50 may be, for example, a global positioning system (GPS) device. The communication information may be, for example, map information and information on a position of the vehicle on a map.

Based on the acquired information, the ECU 10 executes various processes of the control of the vehicle and generates a control signal. Then, the control signal is output to the actuator 60. The control signal may be output to the HMI device 21 in order to transmit information to the operator PS.

The ECU 10 typically includes a memory and a processor. The memory includes a random access memory (RAM) that temporarily stores data, and a read-only memory (ROM) that stores a control program that can be executed by a processor, or various pieces of data of the control program. The processor reads a program from the memory and executes a process according to the program based on the various pieces of data read from the memory.

The ECU 10 includes a request approval determination unit 11 and a control unit 12. The request approval determination unit 11 executes a process for determining whether a request sent to the ECU 10 from the request input device 20 can be approved. Upon determining that the request is approved, the request approval determination unit 11 transmits the request to the control unit 12. The process executed by the request approval determination unit 11 will be described below in detail.

The control unit 12 executes processes of a plurality of controls including the autonomous traveling control and generates a control signal. Further, the control unit 12 executes a process according to the request transmitted from the request approval determination unit 11. When the setting change request is transmitted, the control unit 12 executes the setting change of the control such that the setting change matches the setting change value. More specifically, the processor changes the value of the setting of the control of the control program stored in the memory. When the driving request is transmitted, the control unit 12 cancels the autonomous traveling control and generates a control signal such that the traveling is executed according to an operation amount. In other words, the manual driving by the operator PS is implemented.

The control unit 12 outputs, to the request approval determination unit 11, an autonomous traveling control execution flag, which is 1 during the execution of the autonomous traveling control and 0 when the autonomous traveling control is not being executed. As such, the request approval determination unit 11 can determine whether the control unit 12 is executing the autonomous traveling control.

Each of the request approval determination unit 11 and the control unit 12 may be implemented as a part of processing in the control program, or as a separate processor.

Alternatively, each of the request approval determination unit 11 and the control unit 12 may be composed of a separate ECU. Further, the control unit 12 may be composed of a separate ECU for each of the plurality of controls or for each group of controls. In this case, the ECU 10 is composed of a plurality of ECUs. At this time, the respective ECUs are connected so as to be able to transmit information to each other to the extent that data necessary for executing the processing can be acquired. At least the ECUs of the request approval determination unit 11 are connected so as to be able to transmit information to the respective ECUs composing the control unit 12. Then, when the request approval determination unit 11 approves the request, the request is transmitted to the ECU of the control targeted by the request. Further, the ECU according to the autonomous traveling control transmits the autonomous traveling control execution flag to the request approval determination unit 11.

The actuator 60 is composed of various actuators according to functions, and each actuator is arranged at an appropriate position within the vehicle. The actuator 60 operates according to a control signal sent from the ECU 10. As such, the control by the ECU 10 is implemented.

For example, the ECU 10 executes a process according to the autonomous traveling control, and outputs control signals on acceleration, deceleration, and steering to the actuator 60. Then, by the operations of the actuator 60 according to the control signals, the vehicle autonomously travels along the traveling route.

When the ECU 10 outputs a control signal to the HMI device 21, the HMI device 21 operates according to the control signal. For example, when the ECU 10 executes the process and the request is disapproved or the manual driving is started, a control signal for displaying notification of the above facts is output to the HMI device 21. Then, the HMI device 21 can transmit the information to the operator PS by displaying the notification according to a display signal. In addition, the vehicle may be provided with a speaker as the HMI device 21, and the ECU 10 may output, to the speaker, a control signal for displaying the notification via sound.

Processing of Request Approval Determination Unit

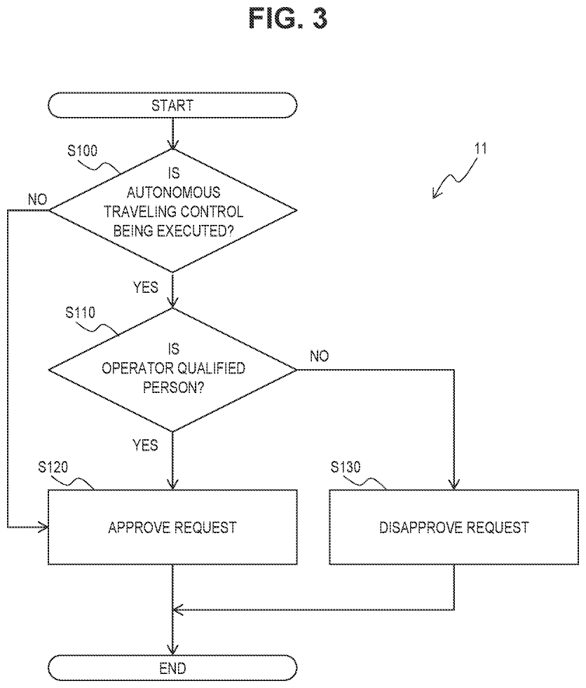

FIG. 3 is a flowchart illustrating processing of the request approval determination unit 11 according to the first embodiment. In the first embodiment, the processing illustrated in FIG. 3 is started when the operator PS operates the request input device 20 and a request is sent to the ECU 10.

In step S100, the request approval determination unit 11 determines whether the control unit 12 is executing the autonomous traveling control. This can be determined by the autonomous traveling control execution flag acquired from the control unit 12. When the autonomous traveling control is being executed (step S100: Yes), the process proceeds to step S110. When the autonomous traveling control is not being executed (step S100: No), the process proceeds to step S120 and the request is approved.

In step S110 (an operator determination process), the request approval determination unit 11 determines whether the operator PS is a qualified person. This is executed based on the operator information acquired from the recognition camera 30. For example, the information on the face or clothes of the operator PS, sent as the operator information, is checked against the data, as criteria for determining whether the person is a qualified person, and sent to the control program in advance. Alternatively, as the operator information, the information on whether the operator PS is a qualified person is sent from the recognition camera 30, and a determination is made according to the information. When the operator PS is a qualified person (step S110: Yes), the process proceeds to step S120 and the request is approved. When the operator PS is not a qualified person (step S110: No), the process proceeds to step S130 and the request is disapproved.

When the request is approved (step S120), the request approval determination unit 11 transmits the request to the control unit 12. When the request is disapproved (step S130), the request is not transmitted to the control unit 12.

By the processes described above, the request according to the operation of the request input device 20 by the operator PS is approved only when the autonomous traveling control is not being executed (when the manual driving is being executed), or when the operator PS is a qualified person even during the execution of the autonomous traveling control. As such, during the execution of the autonomous traveling control, it is possible to prevent the operation that requires attention, such as a control setting change or an operation of the driving operation system 22, from being executed deliberately or by a mistake by a person other than a qualified person, such as an operator of the autonomously driven vehicle.

### Modified Example

The autonomous driving system 100 according to the first embodiment may employ modified modes as below.

### First Modified Example

The operator information may be sent by an authentication device that authenticates the operator PS by an operation by the operator PS. In this case, as an operator recognition device, the authentication device is provided as a substitute for the recognition camera 30. Alternatively, the authentication device is provided in addition to the recognition camera 30.

The authentication device may be, for example, a card reader or a text input device. The authentication of the operator PS is executed by a card possessed by the qualified person, a code, a password, and the like, that are known to the qualified person. In this case, as the operator information, information on whether the operator PS is a qualified person is output. As another example, the authentication device may be a device that executes authentication by biometric information of the operator PS, such as fingerprint authentication or face authentication. In this case, as the operator information, the biometric information of the operator PS is output. Alternatively, a process for determining whether the operator PS is a qualified person may be further executed based on the biometric information of the operator PS, and the information on whether the operator PS is a qualified person may be output as the operator information.

When an authentication device is provided as the operator recognition device, the authentication of the operator PS by the authentication device may be executed before or after the start of execution of the processing of the request approval determination unit 11 illustrated in FIG. 3. In a case where the authentication is executed before the start of the execution of the processing, the authentication is executed by the operator PS by the authentication device and then the execution of the processing is started, and when the request is approved (step S120), the operator PS operates the request input device. Alternatively, the authentication is executed by the operator PS by the authentication device, the operator PS operates the request input device, the execution of the processing is started, and then an approval (step S120) or disapproval (step S130) of the request is determined. In a case where the authentication is executed after the start of the execution of the processing, the authentication is executed by the operator PS by the authentication device before or at the time of execution of the process of step S110, the process of step S110 is executed, and then an approval (step S120) or disapproval (step S130) of the request is determined.

### Second Modified Example

In the request approval determination unit 11, the ECU 10 executes the processing illustrated in FIG. 3 at predetermined cycles, and when the request is approved (step S120), the request input device 20 is in a state where it can be operated. When the request is disapproved (step S130), a control signal may be generated and output such that the request input device 20 is in a state where it cannot be operated.

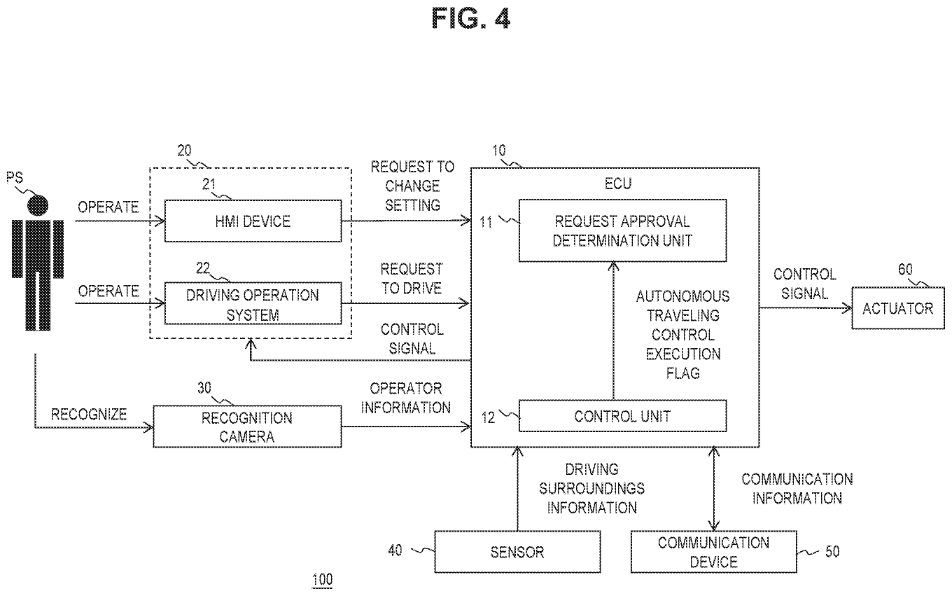

FIG. 4 is a block diagram illustrating a configuration example of the autonomous driving system 100 according to a second modification of the first embodiment. The ECU 10 outputs a control signal to the request input device 20 according to the processing of the request approval determination unit 11. When the request is approved by the processing of the request approval determination unit 11, the ECU 10 outputs a control signal such that the request input device 20 is in a state where it can be operated. When the request is disapproved by the processing of the request approval determination unit 11, the ECU 10 outputs a control signal such that the request input device 20 is in a state where it cannot be operated.

For example, when the HMI device 21 is a touch panel and the request is disapproved, a control signal is output such that a display for inputting the request is not executed. Then, when the request is approved, a control signal is output such that the display for inputting the request is executed. With respect to the driving operation system 22, when the request is disapproved, a control signal for fixing the driving operation system 22 is output such that the driving operation system 22 cannot be operated. Then, when the request is approved, a control signal for releasing the fixation of the driving operation system 22 is output. In this case, the ECU 10 may fix the driving operation system 22 via the actuator 60 provided in the driving operation system 22.

In the autonomous driving system 100 according to the second modified example, the control unit 12 may be able to acquire the request transmitted from the request input device 20 without going through the request approval determination unit 11.

### Second Embodiment

The autonomous driving system 100 according to a second embodiment executes a safety risk calculation process for calculating, by the ECU 10, the risk of the safety indicating the risk according to the safety of the vehicle based on the driving environment information, and a system confidence level calculation process for calculating the system confidence level indicating reliability of the control executed by the ECU 10. Then, the request approval determination unit 11 further considers the safety risk and the system confidence level, and determines whether the request can be approved. Hereinafter, the autonomous driving system 100 according to the second embodiment will be described by appropriately omitting the matters already described in the above-described contents.

Configuration

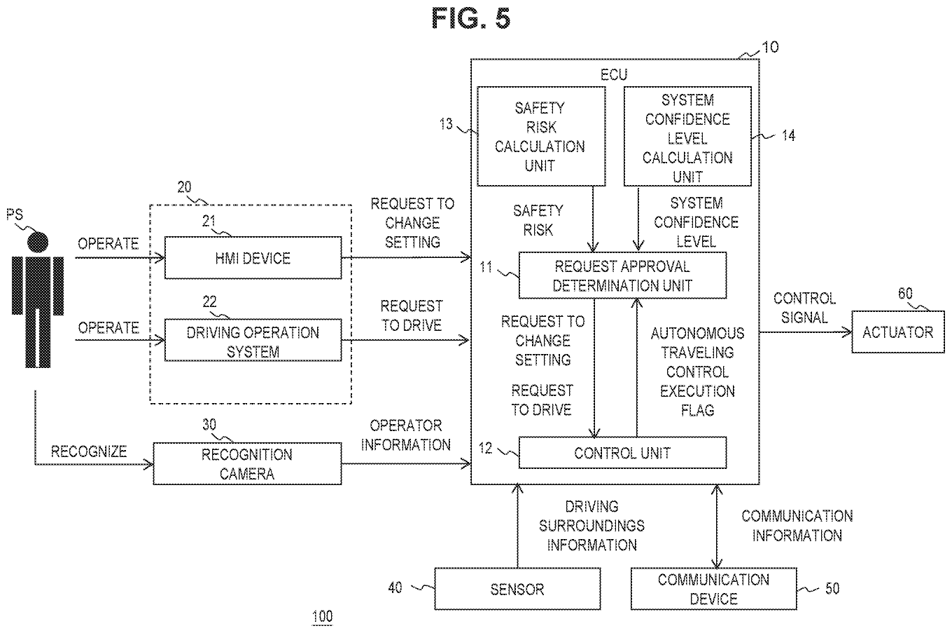

FIG. 5 is a block diagram illustrating a configuration example of the autonomous driving system 100 according to the second embodiment. The autonomous driving system 100 includes an ECU 10, a request input device 20, a recognition camera 30, a sensor 40, a communication device 50, and an actuator 60. The ECU 10 is electrically or wirelessly connected to the request input device 20, the recognition camera 30, the sensor 40, the communication device 50, and the actuator 60, and is configured to be capable of transmitting information.

The request input device 20, the recognition camera 30, the sensor 40, the communication device 50, and the actuator 60 are the same as those described in the first embodiment. The ECU 10 further includes a safety risk calculation unit 13 and a system confidence level calculation unit 14 as compared with the first embodiment.

The safety risk calculation unit 13 executes the safety risk calculation process and outputs the calculated safety risk. The safety risk is transmitted to the request approval determination unit 11.

A risk according to the safety of the vehicle indicated by the risk of the safety may be, for example, a possibility of collision with an actual target on the surroundings of the vehicle. In this case, the safety risk is calculated based on time to collision (TTC) or deceleration required for collision avoidance. In other words, the safety risk is calculated such that the shorter the TTC and the larger the deceleration, the higher the value.

The system confidence level calculation unit 14 executes the system confidence level calculation process and outputs the calculated system confidence level. The system confidence level is transmitted to the request approval determination unit 11.

As an indicator, the system confidence level is given, for example, the accuracy of information of a control, an operation state of the sensor 40, an operation state of the control, or the environment outside the vehicle, or a combination thereof.

A case where the accuracy of the information of the control is given as an indicator is exemplified below. With respect to information given by the image recognition processing, the higher the degree of pattern recognition matching, the higher the system confidence level. The higher the accuracy of map information on a region in which the vehicle is traveling, the higher the system confidence level. The more values deviating from the information detected by the sensor 40, the lower the system confidence level. The information given in advance to the map information (a position, shape, or color of an object) is compared with the information detected by the sensor 40, and the larger the deviation between the pieces of information, the lower the system confidence level.

A case where the operation state of the sensor 40 is given as an indicator is exemplified below. With respect to a sensor that detects information on the surrounding environment of the vehicle, the narrower a range in which the sensor can detect because of a building, an obstacle, or the like, the lower the system confidence level.

A case where the operation state of the control is given as an indicator is exemplified below. The longer an execution time of processing the control, the lower the system confidence level. In the autonomous traveling control, the greater a deviation between a generated traveling route and an actual traveling route, the lower the system confidence level.

A case where the environment outside the vehicle is given as an indicator is exemplified below. The system confidence level is set to a lower value when the weather is bad, for example, rainy or snowy, than when the weather is fine. The system confidence level is set to a lower value when a vehicle is traveling on a road surface on which traveling is difficult, for example, an unpaved road surface, a muddy road surface, or the like, than when traveling on a paved road surface or a dry road surface. The more targets in the surrounding area of the vehicle, the lower the system confidence level.

Each of the safety risk calculation unit 13 and the system confidence level calculation unit 14 may be implemented as a part of processing in the control program or as a processor. Alternatively, each of them may be implemented as an ECU.

Processing of Request Approval Determination Unit

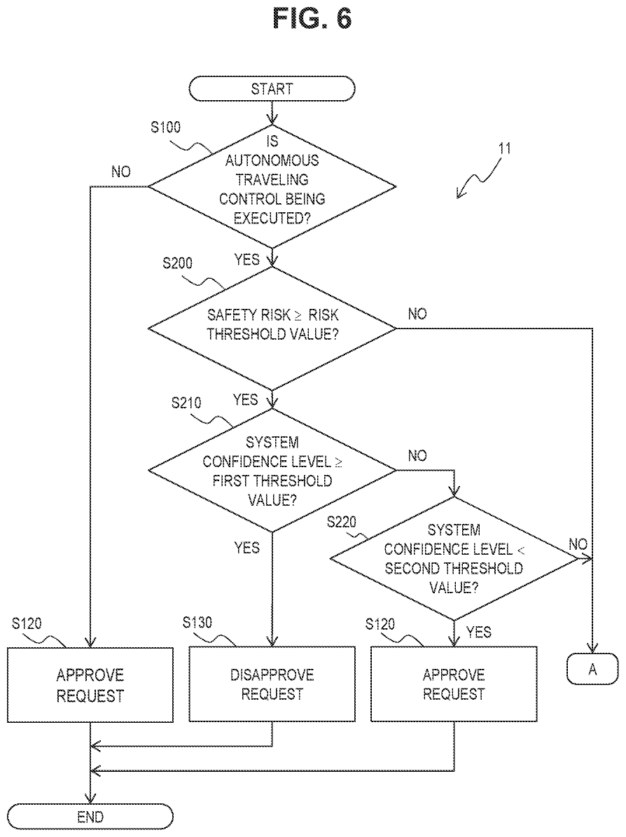

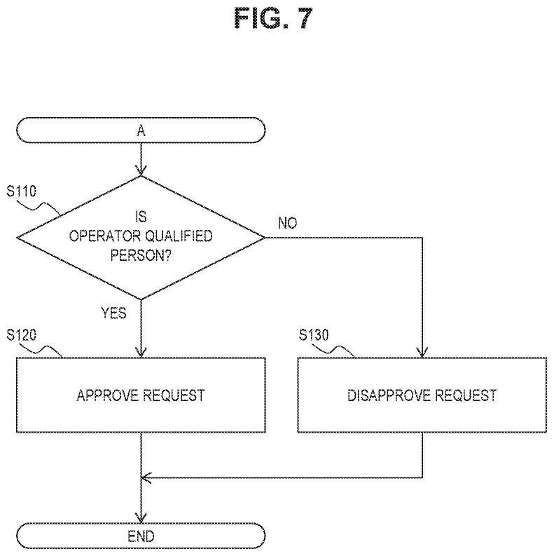

FIGS. 6 and 7 are flowcharts respectively illustrating processing of the request approval determination unit 11 according to the second embodiment. “A” illustrated in FIGS. 6 and 7 corresponds to a point where FIG. 7 continues from FIG. 6 such that FIGS. 6 and 7, or combination of, illustrate one flowchart. In the second embodiment, the processing illustrated in FIGS. 6 and 7 is started when the operator PS operates the request input device 20 and a request is sent to the ECU 10. Processes of steps S100, S110, S120, and S130 are the same as those described in the first embodiment.

Processes of steps S200, S210, and S220 are added to the processing of the request approval determination unit 11 according to the second embodiment as compared with the processing of the request approval determination unit 11 according to the first embodiment illustrated in FIG. 3. The process of step S200 is executed when it is determined in the process of step S100 that the autonomous traveling control is being executed (step S100: Yes).

In step S200, the request approval determination unit 11 determines whether the safety risk is equal to or higher than a predetermined risk threshold value. Here, the risk threshold value is a value given to the control program in advance. The risk threshold value indicates the degree of the safety risk that requires the operation of the control to ensure the safety of the vehicle. For example, when the safety risk is a possibility of collision, the risk threshold value indicates a degree of the safety risk that indicates that collision avoidance is not easy unless the vehicle safety control is activated. This is typically given experimentally and optimally by executing adaptation and the like of the vehicle to which the autonomous driving system 100 is applied.

When the safety risk is equal to or higher than the risk threshold value (step S200: Yes), the process proceeds to step S210. When the safety risk is lower than the risk threshold value (step S200: No), the process proceeds to step S110, and whether the request can be approved is determined according to whether the operator is a qualified person.

In step S210, the request approval determination unit 11 determines whether the system confidence level is equal to or higher than a predetermined first threshold value. Here, the first threshold value is a value given to the control program in advance. The first threshold value indicates the degree of the system confidence level at which the control of the safety of the vehicle can exhibit sufficient performance. This is typically given experimentally and optimally by executing adaptation and the like of the vehicle to which the autonomous driving system 100 is applied.

When the system confidence level is equal to or higher than the first threshold value (step S210: Yes), the process proceeds to step S130 and the request is disapproved. When the system confidence level is lower than the first threshold value (step S210: No), the process proceeds to step S220.

In step S220, the request approval determination unit 11 determines whether the system confidence level is lower than a predetermined second threshold value. Here, the second threshold value is a value given to the control program in advance. The second threshold value indicates the degree of the system confidence level at which there is a concern that the control of the safety of the vehicle cannot exhibit sufficient performance. This is typically given experimentally and optimally by executing adaptation and the like of the vehicle to which the autonomous driving system 100 is applied. The second threshold value is lower than the first threshold value.

When the system confidence level is lower than the second threshold value (step S220: Yes), the process proceeds to step S120 and the request is approved. When the system confidence level is equal to or higher than the second threshold value (step S220: No), the process proceeds to step S110, and whether the request can be approved is determined according to whether the operator is a qualified person.

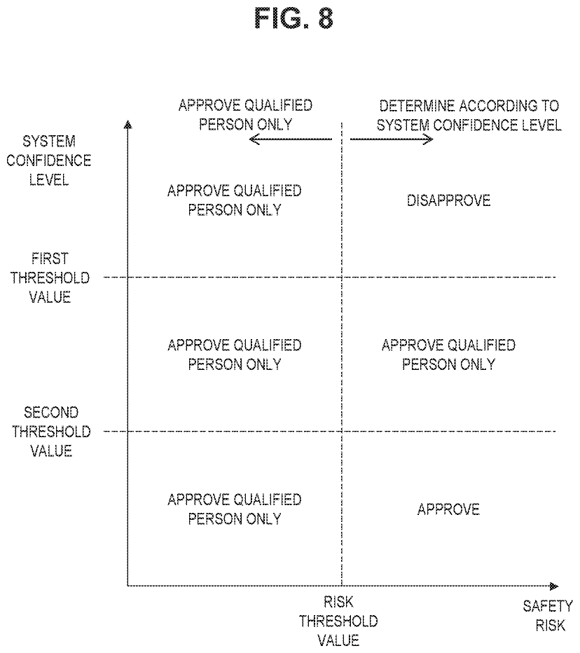

By the process described above, whether the request can be approved is determined in consideration of the safety risk and the system confidence level. FIG. 8 is a conceptual diagram illustrating whether a request according to the safety risk and the system confidence level is implemented by the processing according to the second embodiment. FIG. 8 illustrates a case where the autonomous traveling control is being executed.

In the second embodiment, when the safety risk is lower than the risk threshold value, the request is approved only when the operator is a qualified person, in the same manner as in the first embodiment. On the other hand, when the safety risk is equal to or higher than the risk threshold value, whether the request can be approved is determined according to the system confidence level. As illustrated in FIG. 8, when the system confidence level is equal to or higher than the first threshold value, the request is disapproved regardless of whether the operator is a qualified person. Further, when the system confidence level is lower than the first threshold value and equal to or higher than the second threshold value, the request is approved only when the operator is a qualified person. Then, when the system confidence level is lower than the second threshold value, the request is approved regardless of whether the operator is a qualified person.

As such, when the risk of the safety is high to a certain extent and the vehicle needs to be controlled, it is possible to enhance the safety of the vehicle by determining whether the request can be approved according to the system confidence level. In other words, when the system confidence level is high to a certain extent, it is possible to entrust the driving and the like of the vehicle to the control of the highly reliable autonomous driving system 100 without being influenced by the setting change and the like. On the other hand, when the system confidence level is low to a certain extent, it is possible to approve a person other than a qualified person to operate the request input device and entrust a person to make the determination of the driving and the like of the vehicle.

### Modified Example

The autonomous driving system 100 according to the second embodiment may employ modified modes as below.

### First Modified Example

The operator information may be sent by the authentication device that authenticates the operator PS by an operation by the operator PS. The authentication device is the same as that described in the first modified example of the first embodiment.

### Second Modified Example

In the request approval determination unit 11, the ECU 10 executes the processes illustrated in FIGS. 6 and 7 at predetermined cycles, and when the request is approved (step S120), the request input device 20 is in a state where it can be operated. When the request is disapproved (step S130), a control signal may be generated and output such that the request input device 20 is in a state where it cannot be operated.

### Advantageous Effect

As described above, in the autonomous driving system 100 according to the present embodiment, the request to the ECU 10 is approved only when the autonomous traveling control is not being executed or when the operator is a qualified person, even during the execution of the autonomous traveling control. As such, it is possible to prevent the operation that requires attention, such as a control setting change or an operation of the driving operation system, from being executed deliberately or by a mistake by a person other than a qualified person, such as an operator of the autonomously driven vehicle during the execution of the autonomous traveling control.

Further, the autonomous driving system 100 according to the present embodiment can obtain the above advantageous effects by being suitably mounted on various types of autonomously driven vehicles having various purposes. For example, when the vehicle is an autonomously driven vehicle capable of remote driving and the HMI device 21 and the driving operation system 22 are positioned at places away from the vehicle, it is possible to suitably implement the remote driving by configuring the ECU 10, and the HMI device 21 and the driving operation system 22 to wirelessly execute transmitting of information.

What is claimed is:

1. An autonomous driving system that executes an autonomous traveling control for automatically controlling a traveling of a vehicle, the autonomous driving system comprising:
a control device configured to execute one or more controls of the vehicle including the autonomous traveling control; and
a request input device configured to send various requests to the control device by a human operation,
wherein the control device is configured to:
execute, during execution of the autonomous traveling control, an operator determination process for determining whether an operator who operates the request input device is a qualified person;
approve the request when the operator is a qualified person; and
disapprove the request when the operator is not a qualified person.

2. The autonomous driving system according to claim 1, further comprising an operator recognition device configured to recognize the operator and output operator information on the operator,
wherein the control device is configured to, in the operator determination process, determine whether the operator is a qualified person based on the operator information.

3. The autonomous driving system according to claim 1, further comprising a sensor configured to acquire driving environment information indicating a driving environment of the vehicle,
wherein the control device is configured to:
execute, based on the driving environment information, a process for calculating a safety risk indicating a risk in terms of safety of the vehicle and a process for calculating a system confidence level indicating reliability of the control executed by the control device; and
disapprove, when the safety risk is equal to or higher than a predetermined risk threshold value and the system confidence level is equal to or higher than a predetermined first threshold value, the request regardless of whether the operator is a qualified person.

4. The autonomous driving system according to claim 3, wherein the control device is configured to approve, when the safety risk is equal to or higher than the predetermined risk threshold value and the system confidence level is lower than a predetermined second threshold value, which is lower than the first threshold value, the request regardless of whether the operator is a qualified person.

5. A control method of an autonomously driven vehicle by a control device, the control method comprising:
determining, when a request for a control of the autonomously driven vehicle is sent to the control device at a time of execution of an autonomous traveling control by the control device, whether an operator who sends the request is a qualified person;
approving the request when the operator is a qualified person; and
disapproving the request when the operator is not a qualified person.

6. The control method according to claim 5, further comprising:
calculating a safety risk indicating a risk in terms of safety of the autonomously driven vehicle and a system confidence level indicating reliability of the control executed by the control device based on driving environment information indicating a driving environment of the autonomously driven vehicle; and
disapproving, when the safety risk is equal to or higher than a predetermined risk threshold value and the system confidence level is equal to or higher than a predetermined first threshold value, the request regardless of whether the operator is a qualified person.

7. The control method according to claim 6, further comprising approving, when the safety risk is equal to or higher than the predetermined risk threshold value and the system confidence level is lower than a predetermined second threshold value, which is lower than the first threshold value, the request regardless of whether the operator is a qualified person.
